(19) United States
(12) Patent Application Publication
(10) Pub. No.: US 2005/0248952 A1
(43) Pub. Date: Nov. 10, 2005

(54) Lighting device for pumpkins and other similar articles

(76) Inventors: Hisn-Tien Yao, Taipei (TW); Teng-Huang Chen, Chang Hua Hsien (TW); Andrew A. Boschetto, Sewell, NJ (US)

Correspondence Address: LINIAK BERENATO & WHITE, Suite 240, 6550 Rock Spring Drive, Bethesda, MD, 20817, US

(21) Appl. No.: 11/131,293

(22) Filed: May 18, 2005

Related U.S. Application Data
(63) Continuation-in-part of application No. 10/444,097, filed on May 23, 2003.

(51) Int. Cl. F21V 21/00; F21V 35/00

(52) U.S. Cl. 362/392; 362/276; 362/190

(57) ABSTRACT

An illumination device is adapted to be placed in an interior of an object to illuminate a surrounding area, and comprises a housing, a light source and a mounting base. The housing has an interior sized and adapted to receive an electric power supply, and the mounting base supports the housing in an upright orientation relative to a support surface of the object and an upper end portion opposite the base portion. The illumination device simulates a candle lamp comprises a translucent candlestick member having a light emitting assembly secured to the upper end of the candlestick member. The light emitting assembly includes a base portion, a light emitting device mounted to the base portion and an electronic control unit for controlling operation of the light emitting device. The electronic control unit includes an ambient light sensor provided for automatically turning the light emitting device on if ambient light level is below a predetermined level and for turning the light emitting device off if ambient light level is above the predetermined level. The ambient light sensor protrudes through an opening formed in an outer surface of the base portion of the light emitting assembly and is exposed to ambient light.

This application is a continuation-in-part of U.S. patent application Ser. No. 10/444,097 filed May 23, 2003, which application is currently pending

### FIELD OF THE INVENTION

The present invention relates to an automatic illumination device adapted to be placed in an interior of an object. More particularly, the present invention is directed to an illumination device adapted to be placed in a hollowed-out interior of a pumpkin to illuminate the interior so as to project a decorative image carved in the sidewall thereof.

### BACKGROUND OF THE INVENTION

Pumpkin carving has become a popular past time especially during the Halloween season. In fact, pumpkin carving has become so popular that there is now a demand for a variety of pumpkin carving implements including pumpkin face patterns, carving tools and drilling tools, as well as a variety of pumpkin carving kits. These pumpkin carving implements and kits can be used by children or adults with a carving skill level ranging from a hobbyist to a professional.

Often during the Halloween season, images are carved into pumpkin shells and a lit candle is placed into the pumpkin shell so that the image is brightly illuminated in the dark of night for view by any passers-by. Either short, slender candles or votive candles are typically employed for this purpose. Usually, votive candles are set, unsecured, into the pumpkin. The candles are typically not secured, allowing them to tip over and be extinguished or even permitting them to fall out of the pumpkin.

Safety continues to be a major concern because the flame can catch a costume on fire, particularly when the costumes of children include hanging sheets, scarves and other flammable items.

Another drawback of these existing techniques in illuminating carved pumpkins is that, as the candle burns over a period of time, it diminishes in size thereby effecting overall illumination of the carved pumpkin. Additionally, where the pumpkin is located outdoors, there remains the possibility that a gust of wind will merely extinguish the lit candle.

There is therefore, a need in the industry to provide an alternative means for illuminating the interior of a carved pumpkin or the like. It is further desirable for an illumination device accomplishing this need to eliminate the drawbacks caused by the wax of votive candles, while increasing both illumination time and efficiency. Moreover, a need exists for a lightweight, inexpensive illumination device which may be planted into the fleshy shell of a carved pumpkin so that the pumpkin will securely hold the illumination device. The present invention satisfies these needs and provides these benefits.

### SUMMARY OF THE INVENTION

The present invention provides a new and improved illumination device adapted to be placed in an interior of an object, such as a carved pumpkin or some other fruit or vegetable, to illuminate a surrounding area or an image carved therein.

Another object of the present invention is to provide an illumination device which is configured to be securely supported in the interior of an object to reduce the likelihood of tipping.

A further object of the present invention is to provide an illumination device having a self-contained electrical power supply which is readily replaceable and which is automatically actuated when lighting is needed.

Still a further object of the present invention is to provide an illumination device which is light-weight, easy and safe to use, and inexpensive to manufacture.

In accordance with these objectives, an illumination device according to the present invention is adapted to illuminate a surrounding area. The illumination device may be placed in an interior of an object, such as the hollowed-out interior of a pumpkin having a fleshy bottom wall. The illumination device broadly comprises a stand having a base portion and a body portion extending upwardly from the base portion in a longitudinal direction to terminate at upper end, and a light assembly supported relative to the upper end in an elevated position above the base portion.

The light assembly in accordance with the present invention comprises a candlestick member having a lower end and an upper end, a support member provided at the lower end of the candlestick member, and a light emitting assembly secured to the upper end of the candlestick member. The candlestick member has a substantially cylindrical shape and is made from a translucent material, such as clear, frosted, or textured glass or plastic. Preferably, the light emitting assembly is secured to the upper end of the candlestick member by a threaded coupling.

The light emitting assembly in accordance with the present invention includes a base portion, a light emitting device mounted to the base portion, and an electronic control unit for controlling operation of the light emitting device. The electronic control unit is disposed within the base portion and is operably coupled to the light emitting device. Disposed about a portion of the light emitting device is a translucent cover member ornamentally shaped like a candle flame and provided to enhance and simulate an open flame appearance of a conventional wax candlestick.

Preferably, the light emitting device is in the form of a light emitting diode (LED) mounted to the base portion and having an open flame appearance. Alternatively, the light emitting device may be in the form of a conventional replaceable incandescent light bulb adapted to be connected by a threaded coupling to a light bulb socket provided in the upper end of the candlestick member. It will be appreciated by those skilled in the art that other types of the light emitting device, such as fluorescent lamp, halogen lamp, etc., are also within the scope of the present invention.

In the preferred embodiment, the electronic control unit including an ambient light sensor provided for automatically turning the light emitting device on if ambient light level is below a predetermined level and for turning the light emitting device off if ambient light level is above the predetermined level. Preferably, the ambient light sensor is in the form of a photo-resistor, such as a cadmium sulfide (CDS) photo-resistor.

In accordance with the present invention, the electronic control unit is mounted within the base portion of the light emitting assembly except the ambient light sensor. The ambient light sensor protrudes through an opening formed in an outer peripheral surface of the base portion and is consequently exposed to the ambient light inside the translucent candlestick member. Such an arrangement of the light emitting assembly provides extremely compact packaging, and ease of assembling or replacing the burned LED.

The first exemplary embodiment of the electronic control unit of the light emitting assembly provides a simulated steady burn of an actual candle produced by the LED in low ambient light conditions, while the second exemplary embodiment of the electronic control unit of the light emitting assembly provides a simulated flickering flame of the actual candle produced by the LED in low ambient light conditions. Those skilled in the art will understand, however, that the invention can be used with many different types of control circuits.

The electrical candlestick device according to the present invention can be powered by batteries, solar cells, and/or from a conventional household A.C. outlet, or combinations thereof. In an embodiment utilizing batteries, the batteries can be stored in the candlestick member and/or support member of the electric candle lamp. In embodiments utilizing a solar cell, one or more solar cells located on the candlestick member, support member, or located remotely, is connected to batteries located in the candlestick member and/or support member so that the lamp charges during daylight hours and manually or automatically turns on for dusk and night use.

Therefore, the present invention provides a new and improved electrical candle lamp provided with an ambient light sensor mounted in a light emitting assembly in a compact and simple arrangement allowing easy assembly or placement of the light emitting assembly inside a pumpkin or other hollow article.

These and other objects of the present invention will become more readily appreciated and understood from a consideration of the following detailed description of the exemplary embodiment of the present invention when taken in conjunction with the accompanying drawings, in which:

### BRIEF DESCRIPTION OF THE DRAWINGS

FIG. 1 is a perspective view of the lighting device of this invention disposed in a pumpkin.

FIG. 2 is a side view of an electric candle lamp according to the preferred embodiment of the present invention;

FIG. 3 is a side view of a light emitting assembly according to the preferred embodiment of the present invention;

FIG. 4 is a schematic view of the first exemplary embodiment of an electronic control unit for controlling operation of the light emitting assembly in accordance with the present invention;

FIG. 5 is a schematic view of the second exemplary embodiment of the electronic control unit for controlling operation of the light emitting assembly in accordance with the present invention;

FIG. 6 is a side view of an electric candle lamp according to the alternative embodiment of the present invention.

### DETAILED DESCRIPTION OF PREFERRED EMBODIMENTS

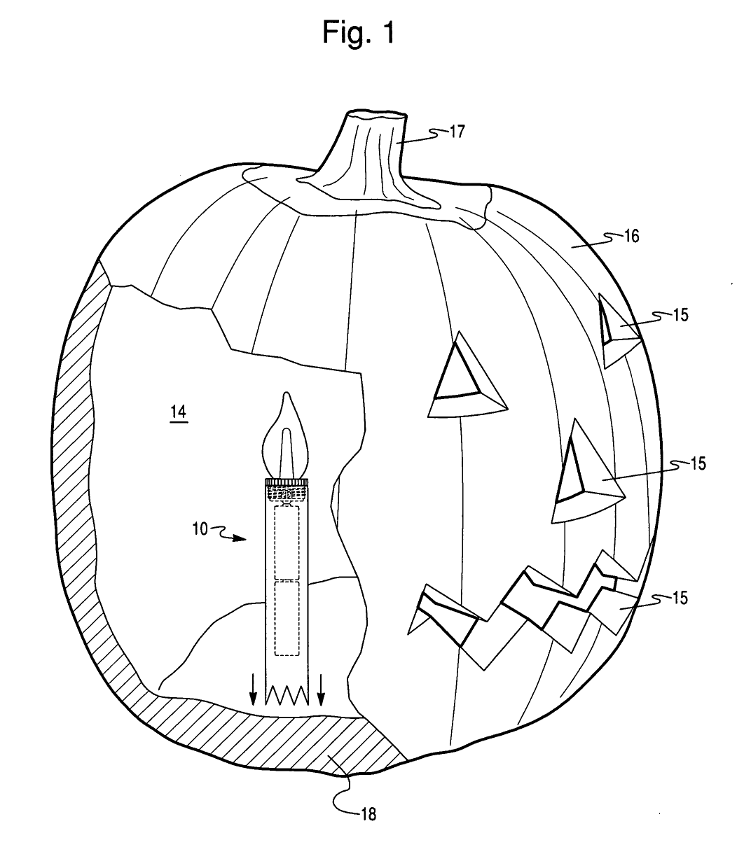

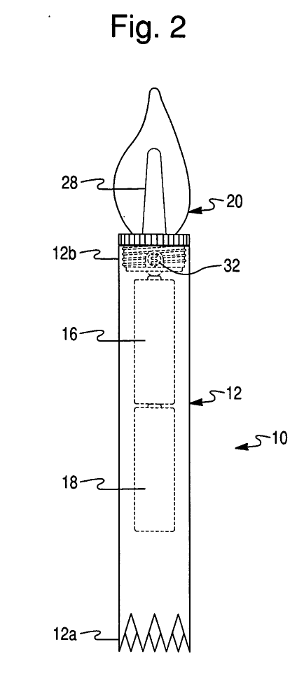

The illumination device 10 according to the exemplary embodiment of the present invention is generally illustrated in FIGS. 1-2. With initial reference to FIG. 1, illumination device 10 is adapted to be placed on a support surface to illuminate a surrounding area. By way of example only and not of limitation, illumination device 10 is particularly adapted to be inserted into an interior 14 of an object, such as a carved pumpkin 16, to illuminate the interior 14. Pumpkin 16 has a fleshy bottom 18 which illumination device 10 penetrates, as described more thoroughly below with reference to FIG. 2. When energized, illumination device 10 emits a bright light which enhances the appearance of various design features 15 carved into pumpkin 16. Unlike prior pumpkin lighting techniques, illumination device 10 does not utilize an actual flame, so there is no potential for fire and no need to remove the stem 17 of pumpkin 16 to provide a chimney for the escape of smoke and heat.

As illustrated in FIG. 2, the electric candle lamp 10 comprises a candlestick member 12, a serrated lower end 12a of the candlestick member 12 for supporting the light on any appropriate support surface, such as the interior bottom of the pumpkin, and a light emitting assembly 20 secured to an upper end 12b of the candlestick member 12. As further illustrated in FIG. 2, preferably, the candlestick member 12 is substantially cylindrical part made from a translucent material, such as clear, frosted, or textured glass or plastic.

As previously mentioned, the candlestick member 12 has a serrated lower end 12a configured to penetrate the fleshy bottom wall of a pumpkin in order to support the stan&s upper end 12b in an upright position above fleshy bottom wall. To this end, and as best shown in FIGS. 1 and 2, the lower end 12a is serrated so that member 12 includes a plurality of downwardly projecting, triangularly shaped teeth operative to penetrate fleshy bottom wall 18. The serration of base portion edge results in a plurality of cut outs formed in the lower end.

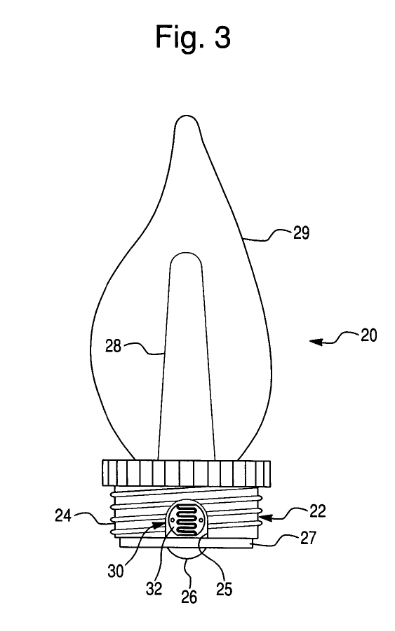

As illustrated in detail in FIG. 3, the light emitting assembly 20 in accordance with the present invention includes a base portion 22, a light emitting device 28 mounted to the base portion 22, and an electronic control unit 30 provided for carrying an electrical current to the light emitting device 28 and for controlling operation of the light emitting device 28. The electronic control unit 30 is disposed within the base portion 22 and is operably coupled to the light emitting device 28. Disposed about a portion of the light emitting device 28 is a translucent cover member 29 ornamentally shaped like a candle flame and provided to enhance and simulate an open flame appearance of a conventional wax candlestick. The base portion 22 is further provided with a pair of spaced contacts 26 and 27.

Preferably, the light emitting assembly 20 is secured to the upper end 12b of the candlestick member 12 by a threaded coupling. Thus, as illustrated in FIG. 3, the base portion 22 of the light emitting assembly 20 has a substantially cylindrical threaded outer peripheral surface 24 complementary a substantially cylindrical threaded inner peripheral surface provided within the upper end 12b of the candlestick member 12.

Preferably, the light emitting device 28 is in the form of a light emitting diode (LED) mounted to the base portion 22 and having an open flame appearance. Alternatively, the light emitting device 28 may be in the form of a conventional replaceable incandescent light bulb adapted to be connected by a threaded coupling to a light bulb socket provided in the upper end 12b of the candlestick member 12. However, it will be appreciated by those skilled in the art that other types of electrical socket connections can be substituted therefore. Moreover, other types of the light emitting device 28, such as fluorescent lamp, halogen lamp, etc., are also within the scope of the present invention.

The electronic control unit 30 of the light emitting assembly 20 in accordance with the present invention further includes an ambient light sensor 32 provided for automatically turning the LED 28 on if ambient light level is below a predetermined level and for turning the LED 28 off if ambient light level is above the predetermined level. Generally, this level may be chosen based upon an average ambient light level available in a given locality at dusk.

Preferably, the ambient light sensor 32 is in the form of a photo-resistor, such as a cadmium sulfide (CDS) photo-resistor. An electrical resistance of the CDS photo-resistor varies as a function of the intensity of ambient light. In this invention, the LED 28 will be automatically switched on in low ambient light conditions as previously described.

It will be appreciated by those skilled in the art that the electronic control unit 30 may have a variable control (not shown) to set light sensitivity of the ambient light sensor 32 to a desired level.

In accordance with the present invention, as illustrated in FIG. 3, the electronic control unit 30 is mounted within the base portion 22 of the light emitting assembly 20 except the ambient light sensor 32. The ambient light sensor 32 protrudes through an opening 25 formed in the outer peripheral surface 24 of the base portion 22 and is consequently exposed to the ambient light inside the translucent candlestick member 12. Such an arrangement of the light emitting assembly 20 provides extremely compact packaging, and ease of assembling or replacing the burned LED 28.

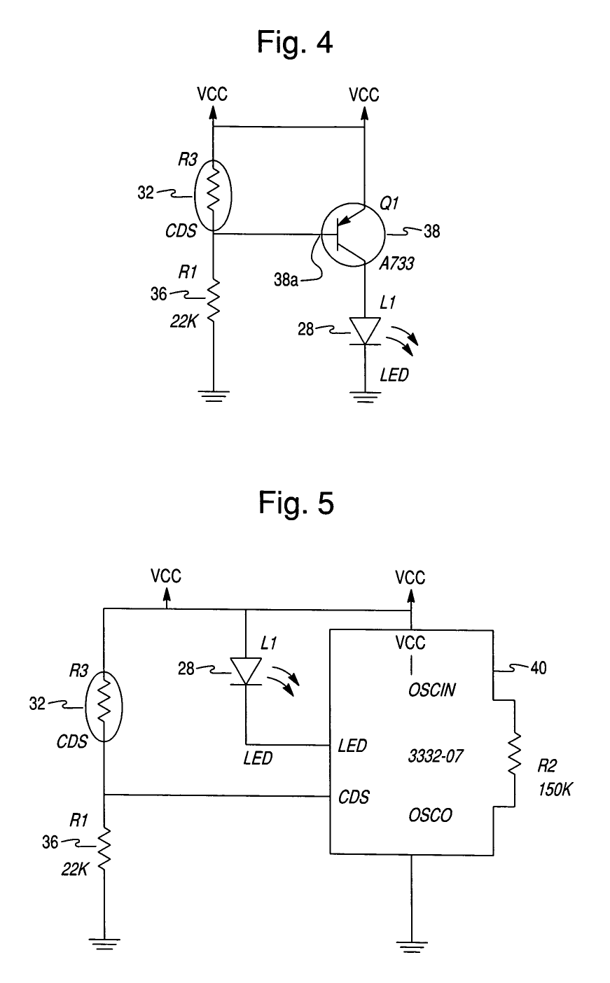

The first exemplary embodiment of the electronic control unit 30 of the light emitting assembly 20 provides a simulated steady bum of an actual candle produced by the LED 28 in low ambient light conditions. The schematic view of an electronic control circuit of the electronic control unit 30 of the light emitting assembly 20 in accordance with the first exemplary embodiment is illustrated in FIG. 4. The control circuit comprises the ambient light sensor 32 for of the CDS photo-resistor having a variable resistance R3, a resistor 36, and a transistor 38. These components together form the control circuit arrangement shown in FIG. 4 providing the simulated steady bum of the light produced by the LED 28 in low ambient light conditions.

The second exemplary embodiment of the electronic control unit 30 of the light emitting assembly 20 provides a simulated flickering flame of the actual candle produced by the LED 28 in low ambient light conditions. The schematic view of the electronic control circuit of the electronic control unit 30 of the light emitting assembly 20 in accordance with the second exemplary embodiment is illustrated in FIG. 5. In this figure, parts corresponding to those of FIG. 4 have been designated by the same reference numeral. The control circuit comprises the ambient light sensor 32 for the CDS photo-resistor having a variable resistance R3, a resistor 36, and an oscillator 40. These components together form the control circuit arrangement shown in FIG. 5 providing the simulated flickering flame of the actual candle produced by the LED 28 in low ambient light conditions by generating a control signal for varying the brightness of light emitted by the LED 28 during spaced periods of gradually increasing duration followed by periods of gradually decreasing duration so as to produce a flicker during successive periods. Thus, the purpose of the oscillator 40 is to vary the amount of one of a current, voltage, or resistance of the power provided to the LED 28 which directly impacts the intensity of the LED 28. The control circuit 20 is not intended to interrupt power provided to the LED 28, but simply to control the amount or potential to change the light intensity or brightness.

Those skilled in the art will understand, however, that the invention can be used with many different types of control circuits.

The electric candle lamp 10 according to the present invention can be powered by 10 electric batteries, solar cells, and/or from a conventional household A.C. outlet, or combinations thereof Preferably, as illustrated in FIG. 2, disposed within the cylindrical candlestick member 12 is provided an electric power supply for the light emitting assembly 20 which may be, for example, in the form of a pair of standard type AA electric batteries 16 and 18 operably coupled to the light emitting assembly 20. It will be appreciated by those skilled in the art that any other appropriate number or types of batteries may be employed, or the batteries can be stored in the support member 14 of the electric candle lamp 10.

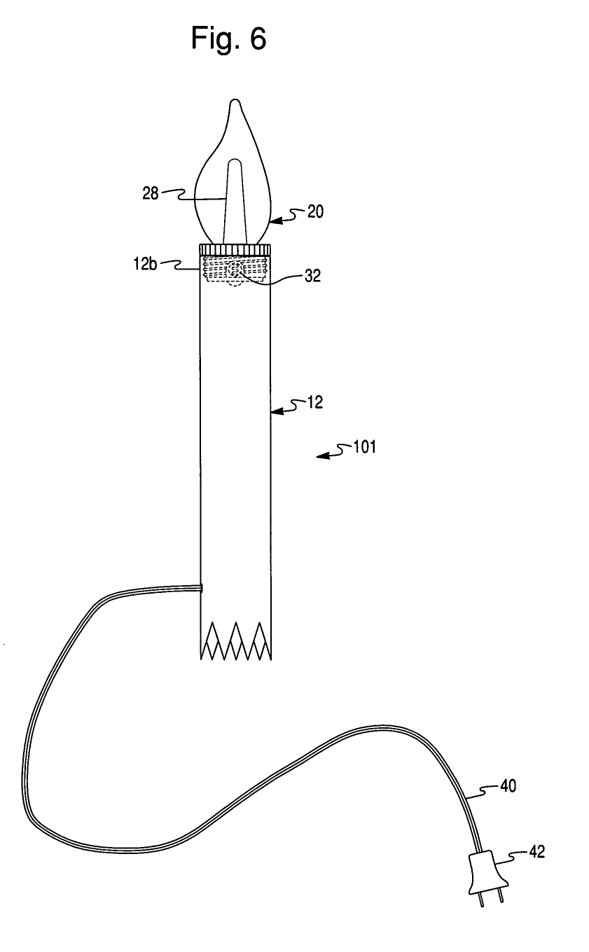

Alternatively, as illustrated in FIG. 6, D.C. operating voltage for the light emitting assembly 20 may be provided by connecting it to a standard household A.C. power outlet 20 (not shown) through an AC/DC converter. In this alternative embodiment utilizing conventional household residential or commercial electric power, an electrical candle lamp 10′ includes a power cord 40 connected to the light emitting assembly 20 at one end and provided with a standard household electrical plug 42 at an opposite end thereof. In this embodiment of the electrical candle lamp 10′ according to the present invention, the power cord 40 extends through the candlestick member 12 to connect with the light emitting assembly 20 located in the upper end 12b of the candlestick member 12, and extends down to the support member 14 of the electrical candle lamp 10′.

In the embodiment, not shown, utilizing a solar cell, one or more solar cells located on the candlestick member 12, support member 14, or located remotely, is connected to batteries located in the candlestick member and/or support member so that the lamp charges during daylight hours and automatically turns on for dusk and night use.

The operation of the electric candle will now be described in relation to the control circuit in accordance with the first exemplary embodiment of the electronic control unit 30 of the light emitting assembly 20 illustrated in FIG. 4. The resistance across the ambient light sensor 32 is inversely proportional to the ambient light level inside the translucent candlestick member 12, i.e. resistance is greatest when the light level is lowest and vice-versa. In high level ambient light, the resistance of the ambient light sensor 32 is quite low relative to the fixed resistance of the resistor 36. Therefore, the voltage drop across the resistor 36 consumes substantially the entirety of the source voltage and consequently, the signal voltage available at the gate 38a of the transistor 38 is insufficient to breakover the transistor 38 to pass current from the cathode to the anode. In low level ambient light, the resistance of the ambient light sensor 32 is increased to an appreciable level. The voltage drop across the ambient light sensor 32, and hence the signal voltage available at the gate 38a of the transistor 38, is now sufficient to breakover the transistor 38 and pass current from the anode to the cathode of the transistor 38, illuminating the LED 28. The ambient light level which activates the ambient light sensor 32 may be chosen based upon the average ambient light level available in a given locality at dusk.

The foregoing description of the preferred exemplary embodiments of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. It is also intended that the scope of the present invention be defined by the claims appended thereto.

1. An electrical candle lamp comprising:
a candlestick member having a lower end and an upper end;
a serrated support portion provided at said lower end of said candlestick member for penetrating a soft surface; and
a light emitting assembly secured to said upper end of said candlestick member;
said light emitting assembly including a base portion, a light emitting device mounted to said base portion and an electronic control unit provided for carrying an electrical current to said light emitting device and for controlling operation of said light emitting device;
said electronic control unit including an ambient light sensor provided for automatically turning said light emitting device on if an ambient light level is below a predetermined level and for turning said light emitting device off if ambient light level is above said predetermined level.

2. The electrical candle lamp as defined in claim 1, wherein said serrated support portion comprises a plurality of triangular teeth formed in said lower end.

3. The electrical candle lamp as defined in claim 1, wherein said ambient light sensor protrudes through an opening formed in an outer peripheral surface of said base portion of said light emitting assembly and is exposed to ambient light.

4. The electrical candle lamp as defined in claim 1, wherein said ambient light sensor is a photo-resistor.

5. The electrical candle lamp as defined in claim 1, wherein said light emitting assembly is removably secured to said upper end of said candlestick member.

6. The electrical candle lamp as defined in claim 5, wherein said base portion of said light emitting assembly is provided with threads for removably engaging complementary threads provided in said upper end of said candlestick member.

7. The electrical candle lamp as defined in claim 1, wherein said candlestick member is made of a translucent material.

8. The electrical candle lamp as defined in claim 7, wherein said ambient light sensor protrudes through an opening formed in an outer peripheral surface of said base portion of said light emitting assembly and is exposed to ambient light within said translucent candlestick member.

9. The electrical candle lamp as defined in claim 1, wherein said light emitting device is a light emitting diode.

10. The electrical candle lamp as defined in claim 1, wherein said light emitting device is an incandescent light bulb.

11. The electrical candle lamp as defined in claim 11, further including an electrical socket provided in said upper end of said candlestick member for accommodating said incandescent light bulb.

12. The electrical candle lamp as defined in claim 1, further including at least one source of electric power operably coupled to said electronic control unit of said light emitting assembly.

13. An illumination device adapted to be placed in an interior of an object that has an interior support surface, said illumination device for illuminating a surrounding area, comprising:
a housing having a housing interior sized and adapted to receive an electric power supply, said housing including a base portion operative to support said housing in an upright orientation relative to the interior support surface of the object and an upper end portion opposite said base portion, said base portion including a plurality of teeth that act as stakes to penetrate the interior support surface of the object; and
a light source disposed at said upper end portion.

14. An illumination device according to claim 13, wherein said plurality of teeth is a plurality of triangular teeth projecting downwardly from said housing.

15. An illumination device according to claim 13, further including a battery suspended within said housing, said battery defining the electric power supply.

16. An illumination device according to claim 15, further comprising a pair of batteries suspended within said housing, said batteries defining the electric power supply.

17. An illumination device according to claim 16, further including a battery chamber sized and adapted to house said batteries.
